(19) United States
(12) Patent Application Publication
(10) Pub. No.: US 2011/0286500 A1
(43) Pub. Date: Nov. 24, 2011

(54) SYNCHRONIZATION DEVICE AND METHOD OF RADIO-FREQUENCY REPEATER

(75) Inventors: Jun-Woo KIM, Daejeon (KR); Young Jo Bang, Daejeon (KR); Byung-Han Ryu, Daejeon (KR); Hyeong Jun Park, Daejeon (KR); Youn Ok Park, Daejeon (KR); Jee Hwan Ahn, Daejeon (KR)

(73) Assignee: ELECTRONICS AND TELECOMMUNICATION RESEARCH INSTITUTE, Daejeon (KR)

(21) Appl. No.: 13/113,549

(22) Filed: May 23, 2011

(30) Foreign Application Priority Data
May 24, 2010 (KR) 10-2010-0048066

(51) Int. Cl. H04B 3/36

(52) U.S. Cl. 375/211

(57) ABSTRACT

A synchronization method of a radio repeater includes: using a first signal, a second signal, and a received signal including the first signal and the second signal to calculate correlation values of the first signal and the second signal; using the first signal correlation value, the second signal correlation value, and the power value of the received signal to output normalized correlation values; subtracting the normalized correlation value of the first signal and the normalized correlation value of the second signal; and detecting a start interval of the second signal based on the subtraction result and outputting a synchronization signal to synchronize the radio repeater.

### CROSS-REFERENCE TO RELATED APPLICATION

This application claims priority to and the benefit of Korean Patent Application No. 10-2010-0048066 filed in the Korean Intellectual Property Office on May 24, 2010, the entire contents of which are incorporated herein by reference.

### BACKGROUND OF THE INVENTION

(a) Field of the Invention

The present invention relates to a synchronization device and method of a radio repeater.

(b) Description of the Related Art

In general, a radio repeater separates downlink signals and uplink signals and amplifies them in a blanket area. A synchronization device of the radio repeater classifies a downlink interval and an uplink interval, and transmits synchronization signals to respective elements of the repeater.

A start of the downlink signal can be detected by recognizing a preamble that is the first symbol of a radio frame in the wireless broadband Internet (WiBro) following the orthogonal frequency division multiplexing time division duplex (OFDM TDD) system that is the standard of the portable Internet service. However, a start of the uplink signal can be known by demodulating a MAP message of the downlink signal or using a signal detection method.

When a process for calculating power of the uplink signal is performed in the signal detection method, the downlink signal also has a relatively large correlation value, and when a process for calculating power of the downlink signal is performed, the uplink signal has a comparatively large correlation value, too. Therefore, in order to catch the start point of the uplink signal by using the signal detection method, it is needed to identify both the uplink signal and the downlink signal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a synchronization device of a radio repeater for accurately detecting a border point of an uplink signal and a downlink signal, and a method thereof.

An exemplary embodiment of the present invention provides a synchronization method of a radio repeater, including: calculating a first signal correlation value and a second signal correlation value by using the first signal, the second signal, and a received signal including the first signal and the second signal; outputting a normalized correlation value of the first signal and a normalized correlation value of the second signal by using first signal correlation value, the second signal correlation value, and a power value of the received signal; subtracting the normalized correlation value of the first signal and the normalized correlation value of the second signal; and detecting a start interval of the second signal based on the subtraction result and outputting a synchronization signal.

Another embodiment of the present invention provides a synchronization device of a radio repeater, including: a complex multiplier for using a first signal, a second signal, and a received signal including the first signal and the second signal to calculate correlation values of the first signal and the second signal, and outputting a first signal correlation value and a second signal correlation value; a power calculator for outputting a power value of the received signal by calculating power of the received signal; a normalizer for outputting a first normalized signal correlation value and a second normalized signal correlation value by using the first signal correlation value and the second signal correlation value output by the complex multiplier and the power value calculated by the power calculator; and a subtractor for acquiring a start interval of the second signal by subtracting the normalized value of the first signal and the normalized correlation value of the second signal.

### BRIEF DESCRIPTION OF THE DRAWINGS

FIG. 1 shows a configuration diagram of a general radio repeater.

FIG. 2 shows a configuration diagram of a synchronization device according to an exemplary embodiment of the present invention.

FIG. 3 shows a flowchart of a method for sensing an uplink signal according to an exemplary embodiment of the present invention.

FIG. 4A to FIG. 4C show a result of calculating signal power according to an exemplary embodiment of the present invention.

FIG. 5 shows a method for sensing an uplink signal according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In the specification, a terminal may indicate a mobile station (MS), a mobile terminal (MT), a subscriber station (SS), a portable subscriber station (PSS), user equipment (UE), and an access terminal (AT), and it may include entire or partial functions of the mobile station (MS), the mobile terminal, the subscriber station, the portable subscriber station, the user equipment, and the access terminal.

In the specification, a base station (BS) may indicate an access point (AP), a radio access station (RAS), a nodeB (Node-B), an evolved Node-B (eNB), a base transceiver station (BTS), and a mobile multihop relay (MMR)-BS, and it may include entire or partial functions of the access point, the radio access station, the nodeB, the evolved Node-B, the base transceiver station, and the mobile multihop relay-BS.

A method for detecting a start point of an uplink signal of a radio repeater according to an exemplary embodiment of the present invention will now be described with reference to accompanying drawings.

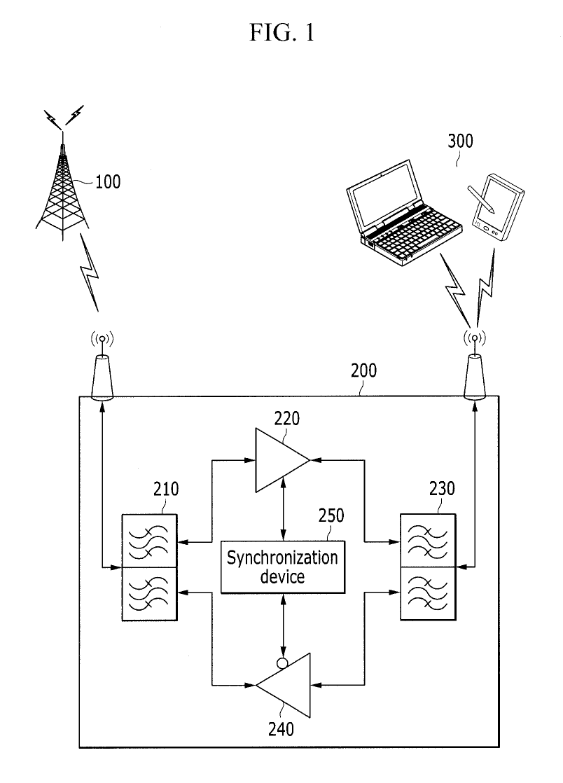

FIG. 1 shows a configuration diagram of a general radio repeater.

As shown in FIG. 1, a radio repeater 200 cooperated with a base station 100 and a terminal 300 includes a first filter/mixer 210, a first signal amplifier 220, a second filter/mixer 230, a second signal amplifier 240, and a synchronization device 250.

The first filter/mixer 210 receives a signal transmitted from the base station 100 to the terminal 300, filters the signal, and transmits the filtered first signal to the first signal amplifier 220. The first filter/mixer 210 receives an amplified second signal from the second amplifier 240, mixes it, and transmits it to the base station 100. Here, the first signal means the downlink signal and the second signal signifies the uplink signal.

The second filter/mixer 230 mixes the first signal amplified by the first signal amplifier 220 and transmits it to the terminal 200 through an antenna. The second filter/mixer 230 receives the signal from the terminal 200 to filter it, and transmits the filtered second signal to the second signal amplifier 240.

The first signal amplifier 220 amplifies the first signal extracted by the first filter/mixer 210 and the synchronization signal output by the synchronization device 250, and transmits it to the second filter/mixer 230 to transmit it to the terminal 200.

The second signal amplifier 240 amplifies the second signal output by the second filter/mixer 230 and the synchronization signal output by the synchronization device 250, and transmits it to the first filter/mixer 210 to transmit it to the base station 100.

The synchronization device 250 generates a synchronization signal in order for other constituent elements of the repeater to identify intervals of the first signal and the second signal and perform a time-division operation.

In general, the start point of the downlink signal, i.e., the first signal, can be found by finding a preamble symbol that is a first OFDM symbol of a radio frame with the length of 5 ms in the downlink. However, the uplink has no such signal and so various methods are proposed.

For example, one method is to demodulate the MAP message of the first signal and acquire a ratio of the first signal versus the second signal established by the base station to find the start point of the second signal. Another method is to sense power of the second signal to detect the start point of the second signal. In addition, another method is to assume that the ratio of the second signal and the first signal is fixed, check a counter from the preamble, and divide the boundary between the second signal and the first signal.

In this instance, when using the method for finding the ratio of the first signal and the second signal defined by the base station by demodulating the MAP message of the first signal, the start point of the second signal can be found in the most accurate way by demodulating information on how many OFDM symbols a scheduler of the base station has allocated to the first signal and the second signal, the information being described in the MAP message of the first signal. However, since the terminal requires entire chipsets used to receive the downlink signal such as a downlink demodulator, a channel decoder, and a medium access control (MAC) so as to check the MAP message, the configuration of the repeater becomes complicated and its cost is increased.

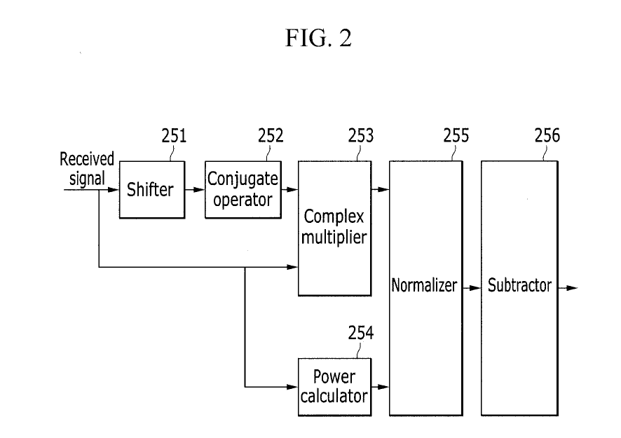

Therefore, the exemplary embodiment of the present invention will provide a method for simplifying the configuration of the repeater and accurately finding the boundary of the uplink signal and the downlink signal. A configuration of a synchronization device will now be described with reference to FIG. 2.

FIG. 2 shows a configuration diagram of a synchronization device according to an exemplary embodiment of the present invention.

As shown in FIG. 2, the synchronization device 250 for generating a synchronization signal, checking an interval for identifying the first signal and the second signal, and providing a start point of the second signal includes a shifter 251, a conjugate operator 252, a complex multiplier 253, a power calculator 254, a normalizes 255, and a subtractor 256.

The shifter 251 receives a signal configured by a plurality of OFDM symbols starting from a preamble, delays the respective OFDM symbols by a predetermined time, and outputs them. That is, when a cyclic prefix (CP) provided at the head of the OFDM symbol is input, the corresponding symbol is delayed by a predetermined time and is then output.

The conjugate operator 252 performs a correlation operation process on the OFDM symbol of the received signal input as a complex number, and outputs a processed signal.

The complex multiplier 253 performs complex multiplication on the OFDM symbol output by the conjugate operator 252 and the received signal and outputs a correlation value.

The power calculator 254 calculates power of the received signal and outputs the power value.

The normalizer 255 normalizes the power value of the received signal output by the power calculator 254 and the correlation value output by the complex multiplier 253 to output a normalized correlation value. In this instance, the normalizer 255 outputs the normalized correlation value for the first signal and the normalized correlation value for the second signal.

The subtractor 256 subtracts the correlation value of the normalized second signal output by the normalizer 255 and the correlation value of the normalized first signal to check the start position of the second signal and output the same so as to output the synchronization signal to the second signal amplifier 240. In this instance, the interval with the subtracted value that is greater than 0 is determined to be an interval of the second signal.

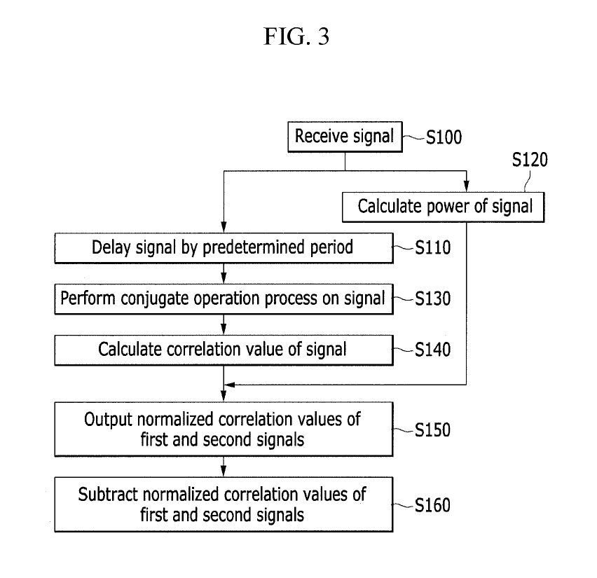

A method for detecting the start position of the second signal and sensing the second signal by using the synchronization device will now be described with reference to FIG. 3.

FIG. 3 shows a flowchart of a method for sensing an uplink signal according to an exemplary embodiment of the present invention.

As shown in FIG. 3, when the radio repeater 200 receives a signal through the antenna (S100), the shifter 251 delays the received signal by a predetermined time (S110). The delayed received signal includes a first signal and a second signal, and each signal is configured with a plurality of NULL symbols and OFDM symbols.

Therefore, upon receiving the signal of one OFDM symbol at a delayed time interval, the conjugate operator 252 performs a conjugate operation process on the conjugate signal (S130), and the complex multiplier 253 receives the conjugate operation processed symbol and performs a complex multiplication process on the received conjugate operation processed symbol and the received signal to output a correlation value (S140). Here, the complex multiplication process used in S140 uses Equation 1.

$$P ( n ) = {\sum }_{i = 0}^{{N}_{CP} - 1} r ( n + i ) \times {r}^{*} ( n + i + N ) \qquad ( Equation 1 )$$

Here, N is the size of fast fourier transform (FFT), and N_{CP} is the length of the cyclic prefix (CP).

The power calculator 254 calculates power of the received signal using Equation 2 (S120).

$$R ( n ) = {\sum }_{i = 0}^{{N}_{CP} - 1} {\vert r ( n + i ) \vert}^{2} \qquad ( Equation 2 )$$

The normalizer 255 receives the signal that is complex-multiplication-processed through Equation 1 and the power of the received signal that is calculated through Equation 2, normalizes them, and outputs a normalized correlation value (S150). In this instance, the normalizer 255 outputs the normalized correlation value by using Equation 3, and the normalized correlation value is divided into a normalized correlation value of the second signal and a normalized correlation value of the first signal.

$$M ( n ) = \frac{{\vert P ( n ) \vert}^{2}}{{R ( n )}^{2}} \qquad ( Equation 3 )$$

When the normalizer 255 outputs the normalized correlation value of the second signal and the normalized correlation value of the first signal as in S150, the subtractor 256 subtracts the normalized correlation value of the second signal and the normalized correlation value of the first signal (S160). The interval with the subtracted result that is greater than 0 becomes the interval of the second signal.

When the boundary of the second signal interval and the first signal interval is made, the synchronization device 250 outputs the synchronization signal to the first signal amplifier 220 and the second signal amplifier 240 to amplify the first signal and the second signal. In this instance, the process for outputting the synchronization signal to the first signal amplifier 220 and the second signal amplifier 240 is well known to a skilled person, and a detailed description thereof will be omitted in the exemplary embodiment of the present invention.

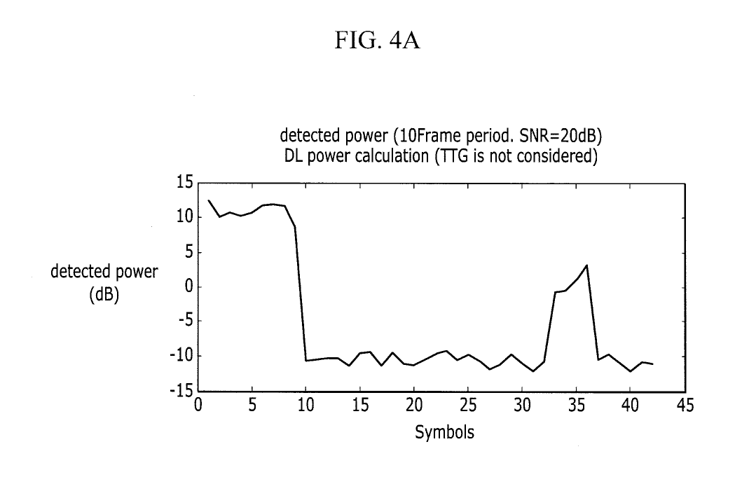

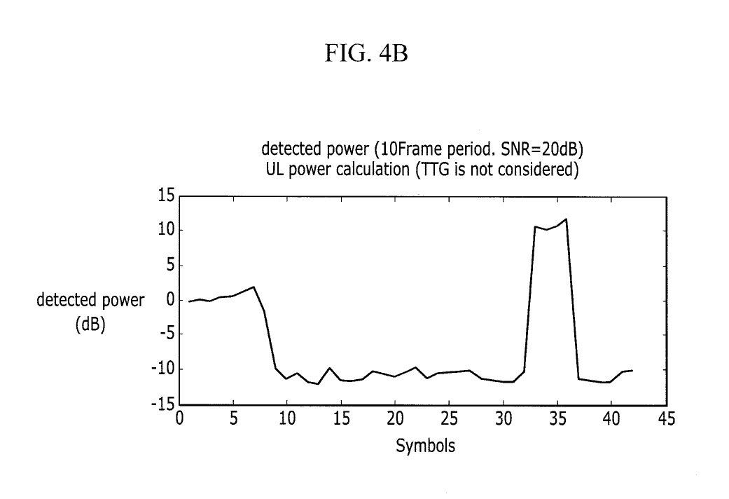

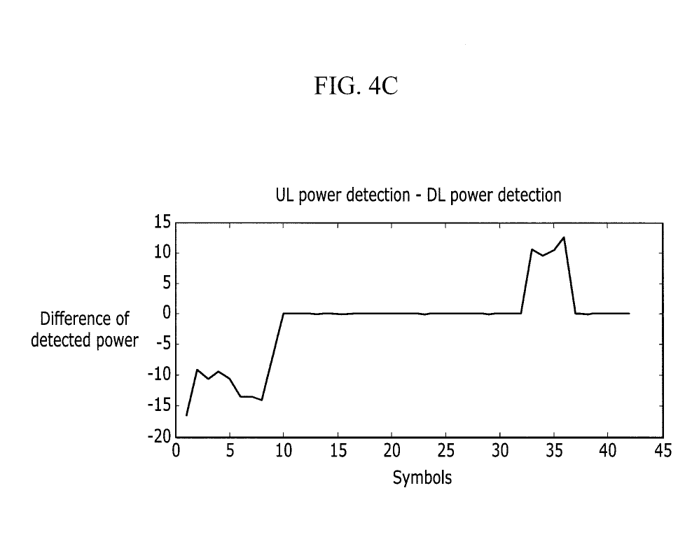

An example of calculating signal power to check the position of the second signal in this way will now be described with reference to FIG. 4A to FIG. 4C.

FIG. 4A to FIG. 4C show a result of calculating signal power according to an exemplary embodiment of the present invention.

FIG. 4A shows an example for indicating a result of calculating power of the uplink signal, FIG. 4B shows an example for indicating a result of calculating power of the downlink signal, and FIG. 4C shows an example for indicating a result of subtracting the power calculated value of the uplink signal from the power calculated value of the downlink signal by the subtractor 256.

As shown in FIG. 4A and FIG. 4B, when the normalizer 255 finds the normalized correlation values of the first signal from among the received signals, energy of the second signal interval is detected to be relatively high. In a like manner, when the normalizer 255 finds the normalized correlation values of the second signal from among the received signals, the value of the first signal interval is detected to be relatively high. Therefore, when the first signal and the second signal are not completely de-coupled, the synchronization device 250 cannot easily identify the value caused by the second signal and the value caused by the first signal in the normalized correlation value.

Accordingly, as shown in FIG. 4C, the subtractor 256 subtracts the power value of the second signal of FIG. 4A and the power value of the first signal of FIG. 4B so that the second signal value has a large positive (+) value, and it controls the value of the undesired first signal interval to be lower than the signal detection value of the NULL symbol interval to thus check the start point of the second signal.

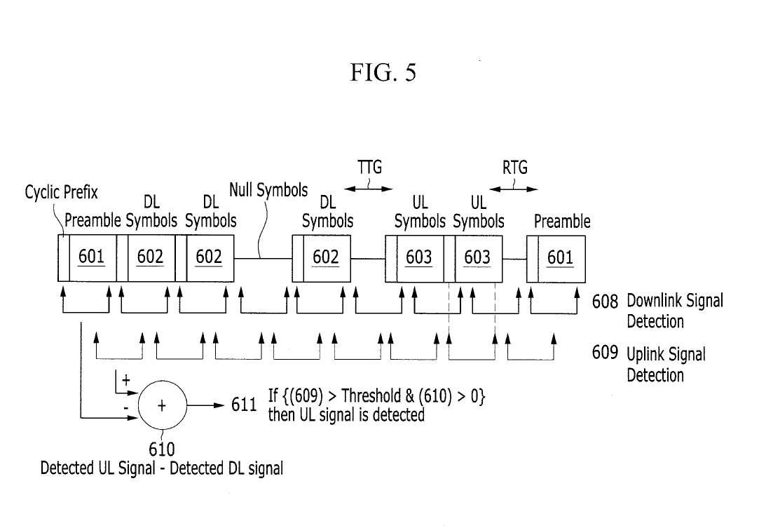

FIG. 5 shows a method for sensing an uplink signal according to an exemplary embodiment of the present invention.

As shown in FIG. 5, the first signal is configured with a plurality of first signal OFDM symbols and NULL symbols with the preamble as a head. The NULL symbol can be given or not depending on multiple user data allocation of the first signal. Since a NULL symbol can be provided in the middle of the first signal, this must be considered when the signal is detected.

The second signal is transmitted with a transmit/receive transition gap (TTG) with the first signal, and is configured with a plurality of OFDM symbols in a like manner of the second signal. A receive/transmit transition gap (RTG) interval is provided between the second signal and the first signal of the next frame, and no signal is transmitted in the TTG and RTG intervals.

The subtractor 256 subtracts the power value of the second signal from the power value of the first signal, and determines the subtracted value to be the desired second signal when the subtracted value is greater than 0 based on the result of sensing the first signal and the result of sensing the second signal. Resultantly, the interval of the second signal, a desired link, is greater than a threshold value of the first signal value, and the interval in which the value generated by subtracting the power value of the second signal from the power value of the first signal has a positive value.

Since all OFDM symbols of the second signal and the first signal are not always transmitted as valid values in the real system, the second signal interval and the first signal interval can be accurately found by repeatedly performing the above-described process over a plurality of frames.

According to an exemplary embodiment of the present invention, a synchronization device of a radio repeater calculates power of an uplink signal and a downlink signal, respectively, and detects a start point of the uplink signal by using the difference so that an accurate border point of the uplink signal and the downlink signal is acquired. Further, a synchronization device of a radio repeater can be simply realized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A synchronization method of a radio repeater, comprising:
calculating a first signal correlation value and a second signal correlation value by using the first signal, the second signal, and a received signal including the first signal and the second signal;
outputting a normalized correlation value of the first signal and a normalized correlation value of the second signal by using first signal correlation value, the second signal correlation value, and a power value of the received signal;
subtracting the normalized correlation value of the first signal and the normalized correlation value of the second signal; and
detecting a start interval of the second signal based on the subtraction result and outputting a synchronization signal.

2. The synchronization method of claim 1, further comprising:
delaying a symbol included in the received signal according to a predetermined time and outputting the symbol; and
outputting the power value of the received signal by calculating power of the received signal.

3. The synchronization method of claim 1, wherein
the outputting of a synchronization signal includes
checking an interval having a value that is greater than 0 from among the subtracted result as a start interval of the second signal.

4. The synchronization method of claim 1, wherein
the first signal correlation value and the second signal correlation value are respectively calculated based on the first signal and an fast fourier transform (FFT) value or the second signal and the FFT value.

5. The synchronization method of claim 4, wherein
the first signal is a downlink signal and the second signal is an uplink signal.

6. A synchronization device of a radio repeater, comprising:
a complex multiplier for using a first signal, a second signal, and a received signal including the first signal and the second signal to calculate correlation values of the first signal and the second signal, and outputting a first signal correlation value and a second signal correlation value;
a power calculator for outputting a power value of the received signal by calculating power of the received signal;
a normalize for outputting a first normalized signal correlation value and a second normalized signal correlation value by using the first signal correlation value and the second signal correlation value output by the complex multiplier and the power value calculated by the power calculator; and
a subtractor for acquiring a start interval of the second signal by subtracting the normalized value of the first signal and the normalized correlation value of the second signal.

7. The synchronization device of claim 6, further comprising:
a shifter for delaying a symbol included in the received signal according to a predetermined time, and outputting the symbol; and
a conjugate operator for performing a correlation operation process on the complex received signal.

8. The synchronization device of claim 6, wherein
the first signal is a downlink signal and the second signal is an uplink signal.
